(19) United States
(12) Patent Application Publication
(10) Pub. No.: US 2015/0053674 A1
(43) Pub. Date: Feb. 26, 2015

(54) OVER-THE-RANGE MICROWAVE OVEN AND VENTILATION PASSAGE SYSTEM OF THE SAME

(71) Applicants: MIDEA GROUP CO., LTD., Beijiao (CN); GUANGDONG MIDEA KITCHEN APPLIANCES MANUFACTURING CO., LTD., Beijiao (CN)

(72) Inventors: Shiyong LIU, Beijiao (CN); Zhifei HUANG, Beijiao (CN); Guangmo JU, Beijiao (CN)

(73) Assignees: MIDEA GROUP CO., LTD., Beijiao (CN); GUANGDONG MIDEA KITCHEN APPLIANCES MANUFACTURING CO., LTD., Beijiao (CN)

(21) Appl. No.: 14/042,778

(22) Filed: Oct. 1, 2013

(30) Foreign Application Priority Data
Aug. 20, 2013 (CN) 201310365817.4
Aug. 20, 2013 (CN) 201320509840.1

(51) Int. Cl. F24C 15/20; H05B 6/80

(52) U.S. Cl. CPC F24C 15/2071; H05B 6/80
USPC 219/757; 126/299 D

(57) ABSTRACT

An over-the-range microwave oven and a ventilation passage system of the same are provided. The over-the-range microwave oven includes an outer casing defining a cooking cavity and an exhaust passage in the outer casing, the exhaust passage defining an inlet formed in a base plate of the outer casing and an outlet; and a baffle plate disposed below and facing the base plate, in which the baffle plate and the base plate are spaced apart from each other to form a smoke collection cavity between the baffle plate and the base plate.

### BACKGROUND OF THE INVENTION

1. Field of the Invention

Embodiments of the present invention generally relate to a microwave oven, and more particularly, to an over-the-range microwave oven and a ventilation passage system of the over-the-range microwave oven.

2. Description of the Related Art

The over-the-range microwave ovens known in the related art are usually mounted over a range and have both a cooking function and an exhaust function of exhausting the dirt-containing air such as hot air and cooking oil smoke generated when cooking by using the range. An outer casing of the over-the-range microwave oven has a cooking cavity and an exhaust passage. An inlet of the exhaust passage is formed in a base plate of the outer casing and a filter screen is disposed at the inlet. In addition, a light for lighting is disposed on the base plate.

In the above known over-the-range microwave oven, the dirt-containing air enters into the exhaust passage directly via the filter screen. Due to a limited area of the filter screen, the suction effect and the exhaust effect of the microwave oven are poor. Moreover, as the filter screen is mounted on the base plate, it can be seen by users directly, thus deteriorating the aesthetics of the appearance of the over-the-range microwave oven. Furthermore, the oil waste contained in the cooking oil smoke tends to adhere onto the base plate, so that the base plate and the light are difficult to clean.

### SUMMARY OF THE INVENTION

Embodiments of the present invention provide an over-the-range microwave oven, comprising: an outer casing defining a cooking cavity and an exhaust passage therein, the exhaust passage defining an inlet formed in a base plate of the outer casing and an outlet; and a baffle plate disposed below and facing the base plate, wherein the baffle plate and the base plate are spaced apart from each other to form a smoke collection cavity between the baffle plate and the base plate.

With the over-the-range microwave oven according to embodiments of the present invention, by disposing the baffle plate below the base plate of the outer casing and defining the smoke collection cavity between the baffle plate and the base plate, the dirt-containing air firstly enters into the smoke collection cavity via an opening thereof and then enters into the exhaust passage via the inlet, thus enhancing the air suction and exhausting effect. Moreover, the inlet is shielded by the baffle plate and cannot be seen by the users, thus improving the aesthetics of the appearance of the over-the-range microwave oven. Furthermore, as the baffle plate is disposed below the base plate, the dirt such as the oil waste in the dirt-containing air does not tend to adhere onto the base plate easily, thus reducing the dirt accumulated on the base plate.

In some embodiments, the over-the-range microwave oven further comprises a light disposed on the baffle plate.

As the light for lighting is disposed on the baffle plate below the base plate, the dirt in the dirt-containing air is not easy to adhere onto the light, so that it is convenient to replace and clean the light.

In some embodiments, a plurality of cell orifices are formed in the baffle plate and extended through the baffle plate in a thickness direction of the baffle plate. Thus, the dirt-containing air additionally enters into the smoke collection cavity via the cell orifices, thus further enhancing the exhaust effect.

In some embodiments, a diameter of each of the plurality of cell orifices is about 1 mm to about 6 mm.

Advantageously, in some embodiments, the over-the-range microwave oven further comprises a filter screen disposed in the exhaust passage. Therefore, the dirt in the dirt-containing air is further filtered.

In some embodiments, the filter screen comprises an inlet filter screen disposed on the base plate and covering the inlet. By disposing the inlet filter screen at the inlet, the dirt in the dirt-containing air can be filtered before entering into the exhaust passage, thus reducing an amount of the dirt entering into the exhaust passage. Moreover, it is easy to clean the filter screen. Furthermore, the filter screen is shielded by the baffle plate, thus improving the aesthetics of the appearance of the over-the-range microwave oven.

In some embodiments, the filter screen further comprises an outlet filter screen disposed at the outlet of the exhaust passage, thus further enhancing the filtering effect on the dirt such as oil in the air.

In some embodiments, the baffle plate and the base plate are spaced by a distance of about 10 mm to about 30 mm.

In some embodiments, an area of the baffle plate is equal to or smaller than that of the base plate. Therefore, the aesthetics of the appearance of the over-the-range microwave oven is further improved.

In some embodiments, the exhaust passage comprises: a first exhaust passage formed between the cooking cavity and the base plate and communicated with the smoke collection cavity via the inlet; a second exhaust passage formed between the cooking cavity and at least one of a rear plate and a side plate of the outer casing; and a third exhaust passage formed between the cooking cavity and a top plate of the outer casing and communicated with the first exhaust passage via the second exhaust passage.

In some embodiments, the baffle plate is detachably mounted on the base plate via a connecting member. Thus, the baffle plate can be detached from the outer casing, which facilitates cleaning and replacement of the baffle plate.

In some embodiments, the connecting member is configured as a connecting column defining a first end connected with the baffle plate and a second end connected with the base plate.

In some embodiments, the over-the-range microwave oven further comprises a sealing plate disposed between the baffle plate and the base plate for closing a portion of an opening of the smoke collection cavity. By closing the portion of the opening of the smoke collection cavity, the suctioning effect can be further improved.

In some embodiments, the baffle plate is mounted on the base plate via the sealing plate, thus reducing the number of elements needed for mounting the baffle plate and reducing a manufacture cost.

In some embodiments, the baffle plate is detachably mounted on the base plate via the sealing plate.

In some embodiments, the base plate and the battle plate are rectangular, and the sealing plate seals at most three of a front opening, a rear opening, a left opening and a right opening of the smoke collection cavity.

In some embodiments, a separation member is disposed between the base plate and the baffle plate, and the base plate and the baffle plate are connected detachably via a screw passing through the separation member.

In some embodiments, the separation member comprises: a conical sleeve defining a small end and a large end; a bottom plate sealing the small end of the conical sleeve; and a flange formed at the large end of the conical sleeve.

Embodiments of the present invention also provide a ventilation passage system of an over-the-range microwave oven. The over-the-range microwave oven has an outer casing defining a cooking cavity therein and a baffle plate disposed below and spaced apart from a base plate of the outer casing, and the ventilation passage system comprises: a smoke collection cavity formed between the base plate and the baffle plate; and an exhaust passage formed between the cooking cavity and the outer casing, defining an inlet formed in the base plate and an outlet, and communicated with the smoke collection cavity via the inlet.

The ventilation passage system according to embodiments of the present invention is simple in structure and has good air suctioning and exhausting effects.

In some embodiments, the exhaust passage comprises a first exhaust passage formed between the cooking cavity and the base plate and communicated with the smoke collection cavity via the inlet; a second exhaust passage formed between the cooking cavity and at least one of a rear plate and a side plate of the outer casing; and a third exhaust passage formed between the cooking cavity and a top plate of the outer casing and communicated with the first exhaust passage via the second exhaust passage.

In some embodiments, at least a portion of an opening of the smoke collection cavity is sealed.

In some embodiments, the base plate and the baffle plate are rectangular, and at most three of a front opening, a rear opening, a left opening and a right opening of the smoke collection cavity are sealed.

This summary is provided to introduce a selection of concepts in a simplified form that are further described below in the Detailed Description of the Embodiments. This summary is neither intended to identify key features or essential features of the claimed subject matter, nor intended to be used as an aid in determining the scope of the claimed subject matter.

### BRIEF DESCRIPTION OF THE DRAWINGS

FIG. 1 is a schematic exploded view of an over-the-range microwave oven according to a first embodiment of the present invention.

FIG. 2 is a schematic perspective view of the over-the-range microwave oven shown in FIG. 1.

FIG. 3 is a schematic sectional view of the over-the-range microwave oven shown in FIG. 1.

FIG. 4 is a schematic perspective view of an over-the-range microwave oven according to a second embodiment of the present invention.

FIG. 5A is a schematic exploded view of an over-the-range microwave oven according to a third embodiment of the present invention.

FIG. 5B is a schematic view of a separation member of the over-the-range microwave oven shown in FIG. 5A.

FIG. 6 is a schematic exploded view of an over-the-range microwave oven according to a fourth embodiment of the present invention.

FIG. 7 is a schematic perspective view of the over-the-range microwave oven shown in FIG. 6.

FIG. 8 is a schematic exploded view of an over-the-range microwave oven according to a fifth embodiment of the present invention.

FIG. 9 is a schematic perspective view of the over-the-range microwave oven shown in FIG. 8.

FIG. 10 is a schematic exploded view of an over-the-range microwave oven according to a sixth embodiment of the present invention.

FIG. 11 is a schematic perspective view of the over-the-range microwave oven shown in FIG. 10.

FIG. 12 is a schematic exploded view of an over-the-range microwave oven according to a seventh embodiment of the present invention.

FIG. 13 is a schematic perspective view of the over-the-range microwave oven shown in FIG. 12.

FIG. 14 is a schematic exploded view of an over-the-range microwave oven according to an eighth embodiment of the present invention.

FIG. 15 is a schematic perspective view of the over-the-range microwave oven shown in FIG. 14.

### DETAILED DESCRIPTION OF THE EMBODIMENTS

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

An over-the-range microwave oven 100 according to embodiments of the present invention will be described below with reference to the drawings.

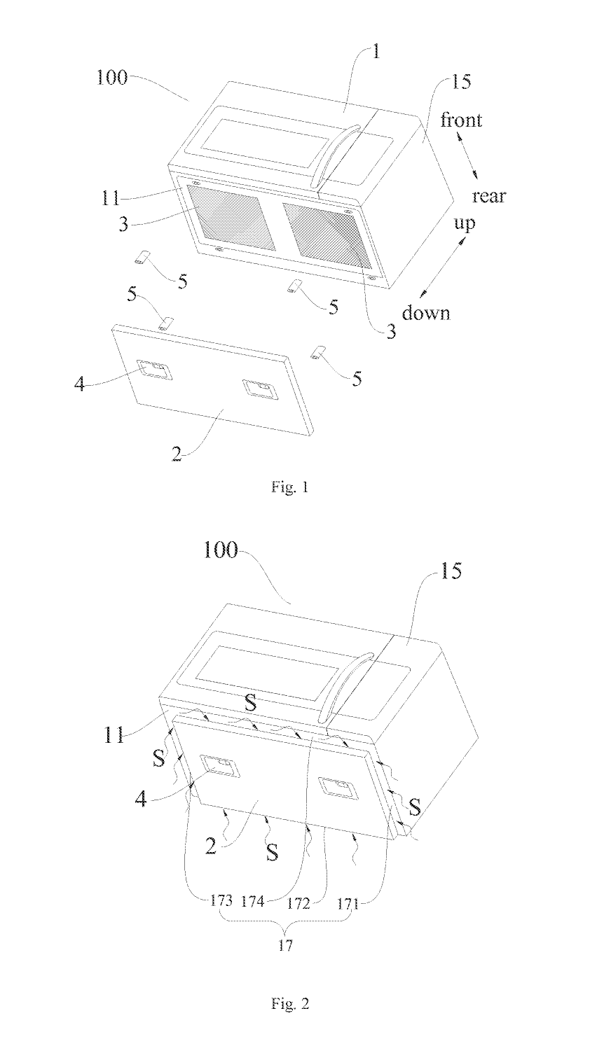

As shown in FIGS. 1-15, the over-the-range microwave oven 100 according to embodiments of the present invention comprises an outer casing 1 and a baffle plate 2.

An exhaust passage 12 and a cooking cavity 13 are formed in the outer casing 1, and the cooking cavity 13 is used to cook food therein. The exhaust passage 12 has an inlet 121 formed in a base plate 11 of the outer casing 1 and an outlet 122. The exhaust passage 12 is used to exhaust the dirt-containing air generated when cooking using the range (not shown) below the microwave oven 100. For example, the dirt-containing air may be cooking oil smoke and/or hot air, and the dirt may be oil waste in the cooking oil smoke. Hereinafter, by way of example and without limitation, the embodiments of the present invention will be described by taking the cooking oil smoke S as an example of the dirt-containing air and taking the oil waste as the dirt.

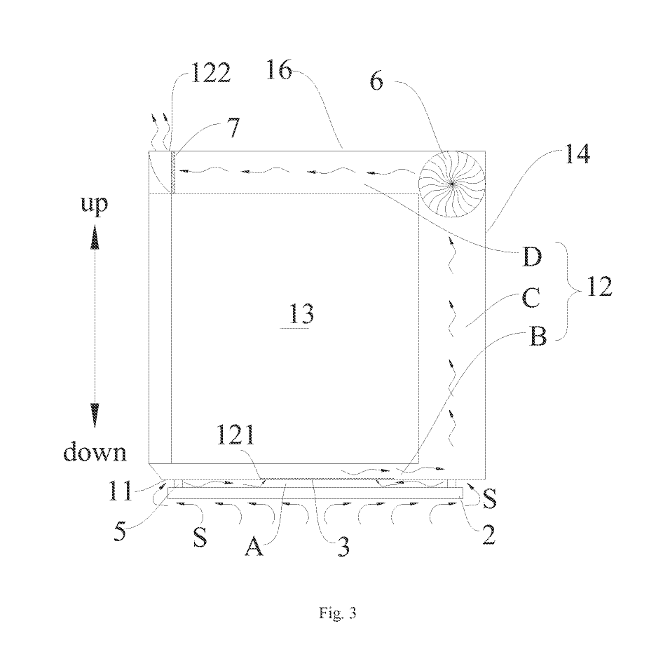

As shown in FIGS. 2-3, the baffle plate 2 is disposed below and faces the base plate 11, and the baffle plate 2 and the base plate 11 are spaced by a predetermined distance. In one example, the baffle plate 2 and the base plate 11 are spaced by a distance of about 10 mm to about 30 mm. Thus, a smoke collection cavity A (may be also named as smoke collection gap, smoke collection space or air intake space) is defined between the baffle plate 2 and the base plate 11.

A periphery of the smoke collection cavity A is opened so as to form an opening 17 thereof, namely, an annular opening (slot) is formed between the base plate 11 and a peripheral edge of the baffle plate 2. In other words, the opening 17 of the smoke collection cavity A is extended over the whole periphery of the smoke collection cavity A in a circumferential direction of the smoke collection cavity A.

The cooking oil smoke S enters into the smoke collection cavity A via the opening 17 (i.e., the annular slot between the base plate 11 and the peripheral edge of the baffle plate 2) of the smoke collection cavity A, and then enters into the exhaust passage 12 via the inlet 121. In other words, the cooking oil smoke S is suctioned into the smoke collection cavity A via the periphery of the smoke collection cavity A.

Those having ordinary skill in the art will appreciate that the baffle plate 2 at least shields the inlet 121 when viewing from down to up. In other words, the baffle plate 2 at least shields the area occupied by the inlet 121 in the base plate 11, and the baffle plate 2 is dimensioned in such a way that the inlet 121 is located within the region of the baffle plate 2 in a horizontal projection plane.

In some embodiments, the area of the baffle plate 2 may be equal to that of the base plate 11, that is, the peripheral edge of baffle plate 2 is aligned with that of the base plate 11 in the up and down direction. In other words, in the horizontal projection plane, the baffle plate 2 is coincided with the base plate 11. Alternatively, the area of the baffle plate 2 may be smaller than that of the base plate 11, that is, the peripheral edge of the base plate 11 radially extends outwardly beyond that of the baffle plate 2. In other words, in the horizontal projection plane, the baffle plate 2 is located in the region of the base plate 11. For example, the peripheral edges of the baffle plate 2 and the base plate 11 may be spaced by a distance of about 10 mm to about 30 mm in a radial direction of the base plate 11. As mentioned above, the baffle plate 2 shall shield the inlet 121, so that the baffle plate 2 shall shields the inlet filter screen 3 when the inlet filter screen 3 is mounted at the inlet 121.

Those having ordinary skill in the art will appreciate that, an exhaust motor 6 for generating a suction force may be disposed in the exhaust passage 12, such that the cooking oil smoke S can be suctioned forcedly into the smoke collection cavity A, and then suctioned into the exhaust passage 12 and exhausted from the outlet 122. Certainly, other known components of the over-the-range microwave oven 100 such as a magnetron for generating microwave may be disposed in the outer casing 1, for example disposed in a machine cavity defined in the outer casing 1, and detailed descriptions thereof will be omitted here.

With the over-the-range microwave oven 100 according to embodiments of the present invention, by disposing the baffle plate 2 below the base plate 11 and defining the smoke collection cavity A between the baffle plate 2 and the base plate 11, the cooking oil smoke S can enter into the smoke collection cavity A via the opening 17 thereof without limitation by the size of the inlet 121, thus improving the effect of suctioning the dirt-containing air into the smoke collection cavity A and exhausting it via the exhaust passage 12. Moreover, the inlet 121 is shielded by the baffle plate 2 and cannot be seen by the users, thus improving the aesthetics of the overall appearance of the over-the-range microwave oven 100. In addition, as the baffle plate 2 is disposed below the base plate 11, the cooking oil smoke is not easily to adhere to the base plate 11, thus reducing the oil waste accumulated on the base plate 11.

In the embodiment shown in FIGS. 1-3, the baffle plate 2 is substantially parallel to the base plate 11. Alternatively, the baffle plate 2 may be slightly inclined with respect to the base plate 11. As shown in FIGS. 2 and 3, by way of example and without limitation, the baffle plate 2 and the base plate 11 are substantially rectangular. Alternatively, the baffle plate 2 may be circular. Advantageously, the baffle plate 2 and the base plate 1 have the same shape and size.

In some embodiments, a filter screen is disposed in the exhaust passage 12. Advantageously, the filter screen comprises an inlet filter screen 3 disposed on the base plate 11 and covering the inlet 121 and an outlet filter screen 7 disposed at the outlet 122 of the exhaust passage 12. The inlet filter screen 3 filters the oil waste in the cooking oil smoke S before the cooking oil smoke S enters into exhaust passage 12 from the smoke collection cavity A, thus reducing the oil waste entering into the exhaust passage 12. The outlet filter screen 7 further filters the cooking oil smoke entering into the exhaust passage 12, thus reducing the oil waste in the exhausted cooking oil smoke.

The inlet filter screen 3 may be mounted on the base plate 11. In some examples, the inlet filter screen 3 is detachably mounted on base plate 11. Thus, when too much oil waste is accumulated on the inlet filter screen 3, the inlet filter screen 3 can be detached for cleaning or replacement.

Alternatively, the inlet filter screen 3 may be integrally formed with the base plate 11. For example, a plurality of micro-pores may be formed in a predetermined region of the base plate 11, such that the predetermined region of the base plate 11 constitutes the inlet filter screen 3 and these micro-pores may be considered as the mesh holes of the filter screen 3 as well as the inlet 121.

As shown in FIG. 1, by way of example and without limitation, two rectangular inlet filter screens 3 spaced apart from each other in a left and right direction are disposed on the base plate 11. In other words, the exhaust passage 12 has two inlets 121. The inlet filter screen 3 may also be circular and three or more inlet filter screens 3 may be disposed.

In some embodiments, when the inlet filter screen 3 is mounted at the inlet 121 in the base plate 11, the baffle plate 2 shields the inlet filter screen 3. Thus, the filter screen 3 cannot be seen from outside, thus improving the aesthetics of the appearance of the over-the-range microwave oven 100. Those having ordinary skill in the art will appreciate that, when a plurality of inlet filter screens 3 are disposed on the base plate 11, the baffle plate 2 shields all the inlet filter screens 3.

As shown in FIGS. 1 and 2, a light 4 for illumination may be disposed on the baffle plate 2. As the light 4 is disposed on the baffle plate 2 below the base plate II, the oil waste in the cooking oil smoke S is not easy to adhere to the light 4, thus facilitating the replacement and cleaning of the light 4. In FIGS. 1 and 2, by way of example and without limitation, two lights 4 are disposed on the baffle plate 2.

In some embodiments, advantageously, the baffle plate 2 is detachably mounted on the base plate 11 via a connecting member. Thus, the baffle plate 2 can be detached from the base plate 11, which facilitates the cleaning and replacement of the baffle plate 2 and the light 4. Alternatively, the baffle plate 2 may also be connected with a side plate 15 of the outer casing 1 via a connecting member.

As shown in FIG. 1, the connecting member may be a connecting column 5 having a lower end connected with the baffle plate 2 and an upper end connected with the base plate 11. The connecting column 5 may be connected with the baffle plate 2 and the base plate 11 via screws. Advantageously, when seen from down to up, the connecting column 5 is shielded by the baffle plate 2, thus further improving the aesthetics of the overall appearance of the over-the-range microwave oven 100.

Alternatively, the baffle plate 2 may also be mounted on the base plate 11 via other means such as a bolt.

As shown in FIGS. 1-3, in some embodiments, the exhaust passage 12 comprises a first exhaust passage B, a second exhaust passage C and a third exhaust passage D.

The first exhaust passage B is formed between the cooking cavity 13 and the base plate 11 and communicated with the smoke collection cavity A via the inlet filter screen 3. The second exhaust passage C is formed between the cooking cavity 13 and at least one of a rear plate 14 and a side plate 15 of the outer casing 1. The third exhaust passage D is formed between the cooking cavity 13 and a top plate 16 of the outer casing 1 and communicated with the first exhaust passage B via the second exhaust passage C.

As shown in FIG. 3, the first exhaust passage B and the third exhaust passage D extend substantially in a horizontal direction and the second exhaust passage C extends substantially in an up and down direction. The exhaust motor 6 may be disposed at a joint of the second exhaust passage C and the third exhaust passage D.

The operating of the over-the-range microwave oven 100 according to embodiments of the present invention will be described below.

When the cooking oil smoke is generated above the range, the exhaust motor 6 is started, and the cooking oil smoke S is suctioned into the smoke collection cavity A via the opening 17 thereof, then passes through the inlet filter screen 3 and enters into the first exhaust passage B. The inlet filter screen 3 filters off the oil waste in the cooking oil smoke S. The filtered cooking oil smoke S then enters into the second exhaust passage C and the third exhaust passage D sequentially, and is discharged from the outlet 122 while passing through the outlet filter screen 7.

As the baffle plate 2 is disposed, the cooking oil smoke S enter into the smoke collection cavity A via the opening of the smoke collection cavity A (i.e., from the periphery of the smoke collection cavity A) without limitation by the area of the inlet filter screen 3 (the inlet 121), thus improving the air suctioning and exhausting effects. Moreover, the oil waste in the cooking oil smoke S is not easily adhered onto the base plate 11, thus reducing the oil waste accumulated on the base plate 11. Furthermore, as the inlet filter screen 3 is shielded by the baffle plate 2, the aesthetics of the overall appearance of the over-the-range microwave oven 100 is improved.

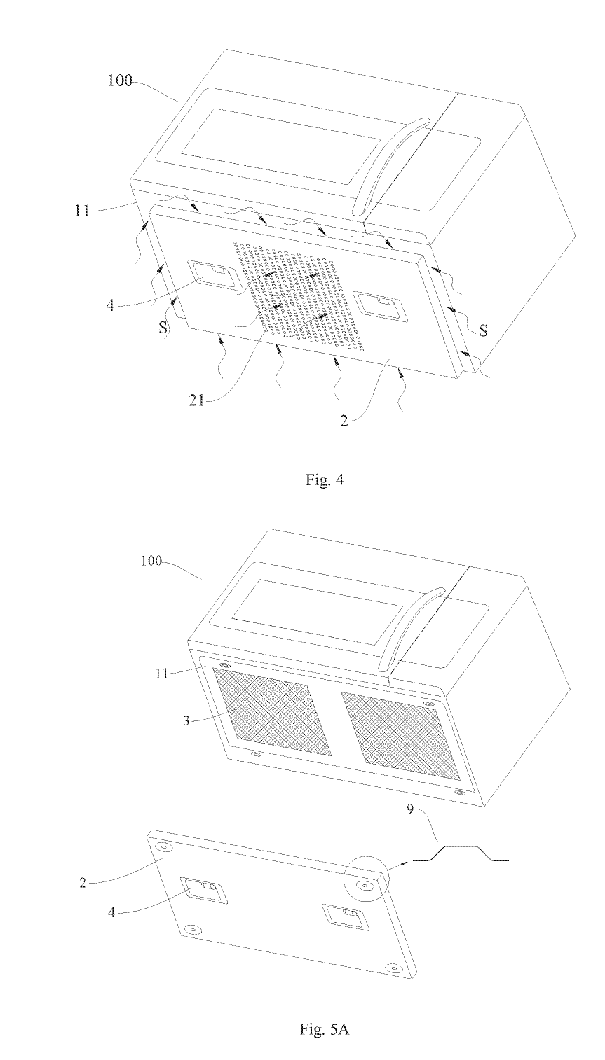

FIG. 4 is a schematic perspective view of an over-the-range microwave oven according to another embodiment of the present invention. In FIG. 4, a plurality of cell orifices 21 are formed in the baffle plate 2 and penetrated through the baffle plate 2 in a thickness direction of the baffle plate 2. The cooking oil smoke S additionally enters into the smoke collection cavity A via the cell orifices 21, thus further improving the suctioning effect. In the embodiment shown in FIG. 4, the plurality of cell orifices 21 are arranged into a rectangular array and located in a center of the baffle plate 2. Advantageously, a diameter of each of the plurality of cell orifices 21 is about 1 mm to about 6 mm. A size of the cell orifice 21 may be equal to or greater than that of the mesh holes of the inlet filter screen 3.

In the embodiment shown in FIG. 5A, a separation member 9 is disposed between the base plate 11 and the baffle plate 2 to separate the baffle plate 2 from the base plate 11. By disposing the separation member 9, a stability of the baffle plate 2 is enhanced. The base plate 1 and the baffle plate 2 are connected detachably via a screw passing through the separation member 9.

As shown in FIGS. 5A and 5B, the separation member 9 is basin-shaped. More particularly, the separation member 9 comprises a conical sleeve 92, a bottom plate 93 and a flange 94. The bottom plate 93 seals a small end (the upper end in FIG. 5A) of the conical sleeve 92, and the flange 94 is formed at a large end (the lower end in FIG. 5A) of the conical sleeve 92 and extended outwards in a radical direction. The bottom plate 93 may be considered as a bottom of the basin-shaped separation member 9. A through hole 91 is formed in the base plate 93 for passing the screw connecting the base plate 11 with the baffle plate 2. The conical sleeve 92, the bottom plate 93 and the flange 94 may be integrally formed.

As will be readily understood by those skilled in the art, the separation member 9 is not limited to that shown in FIG. 5B. For example, the separation member 9 may be a substantially U-shaped elastic sheet, and a flanged edge extended outwards may be formed at a free end of a side wall of the U-shaped elastic sheet, thus improving the stability of the baffle plate 2.

In some embodiments, the over-the-range microwave oven 100 may further comprise a sealing plate 8. The sealing plate 8 is disposed between the baffle plate 2 and the base plate 11 for closing a portion of the opening 17 of the smoke collection cavity A, that is, the sealing plate 8 blocks off the portion of the opening 17 of the smoke collection cavity A so as to prevent the cooking oil smoke from entering the smoke collection cavity A via the portion of the opening 17, thus further improving the air suctioning and exhausting effects.

Advantageously, the baffle plate 2 may be mounted on the base plate 11 via the sealing plate 8. More advantageously, the baffle plate 2 may be detachably mounted on the base plate 11 via the sealing plate 8, for example, the sealing plate 8 is connected with the baffle plate 2 and the base plate 11 via bolts. Thus, the connecting column 5 can be substituted by the sealing plate 8.

As will be readily understood by those skilled in the art, a plurality of through holes (not shown) similar to the cell orifices 21 may be formed in the sealing plate 8, such that the cooking oil smoke S can enter into the smoke collection cavity A via these through holes in the sealing plate 8.

For example, when the base plate 11 and the baffle plate 2 are rectangular, the smoke collection cavity A have a front opening 174, a rear opening 172, a left opening 173 and a right opening 171, that is, the opening of the smoke collection cavity A is divided into four openings. The sealing plate 8 seals at most three of the front opening 174 (front side), the rear opening 172 (rear side), the left opening 173 (left side) and the right opening 171 (right side) of the smoke collection cavity A. In other words, the sealing plate 8 may seal one, two, or three of the front opening 174 (front side), the rear opening 172 (rear side), the left opening 173 (left side) and the right opening 171 (right side) of the smoke collection cavity A.

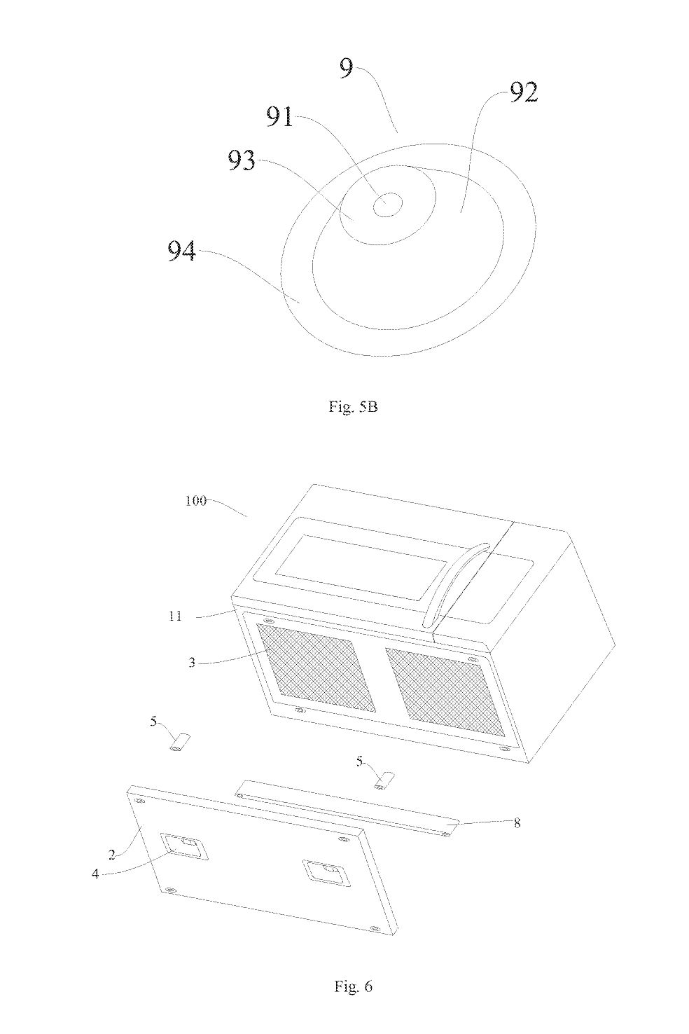

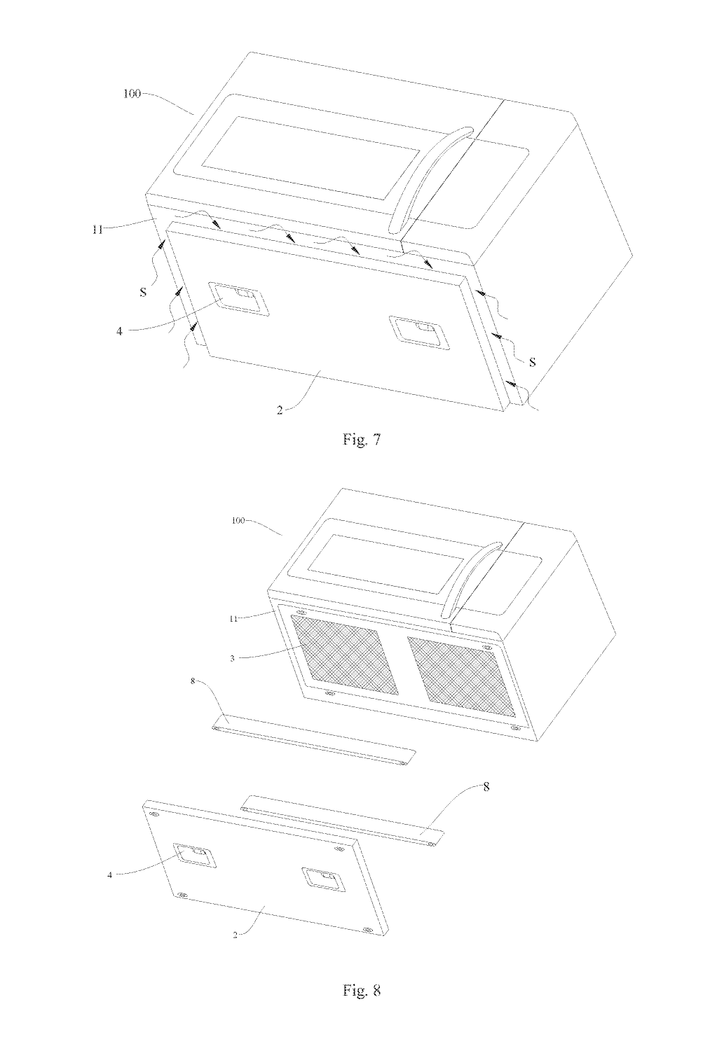

In the embodiment shown in FIG. 6, the baffle plate 2 may be mounted detachably on the base plate 11 via the connecting column 5 and the sealing plate 8, and the sealing plate 8 seals the rear opening 172 of the smoke collection cavity A. More particularly, two connecting columns 5 are disposed adjacent to a front edge of the baffle plate 2 and spaced apart from each other in the left and right direction, and the sealing plate 8 connects a rear edge of the baffle plate 2 with the base plate 11 and seals the rear opening 172 of the smoke collection cavity A. Thus, the cooking oil smoke S enters into the smoke collection cavity A via the front opening 174, the left opening 173 and the right opening 171, as shown in FIG. 7.

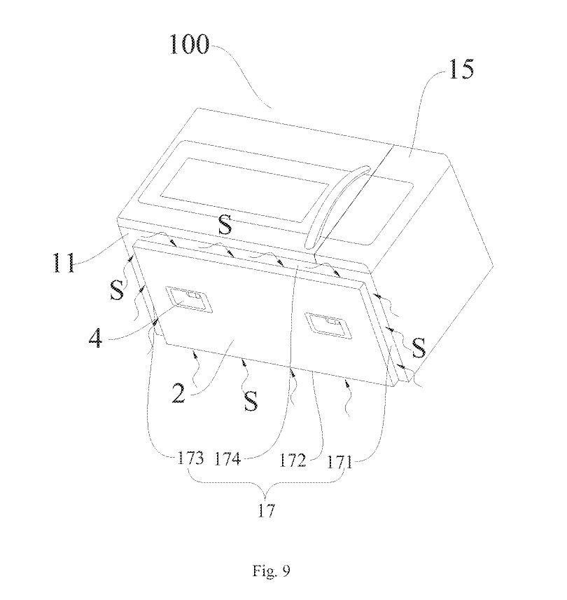

In the embodiment shown in FIG. 8, the baffle plate 2 is connected with the base plate 11 via two sealing plates 8, and the two sealing plates 8 seal the front opening 174 and the rear opening 172 of the smoke collection cavity A respectively. In other words, one sealing plate 8 connects the front edge of the baffle plate 2 with the base plate 11 and seals the front opening 174 of the smoke collection cavity A, while the other sealing plate 8 connects the rear edge of the baffle plate 2 and the base plate 11 and seals the rear opening 172 of the smoke collection cavity A. Thus, the cooking oil smoke S enters into the smoke collection cavity A via the left opening 173 and the right opening 171, as shown in FIG. 9.

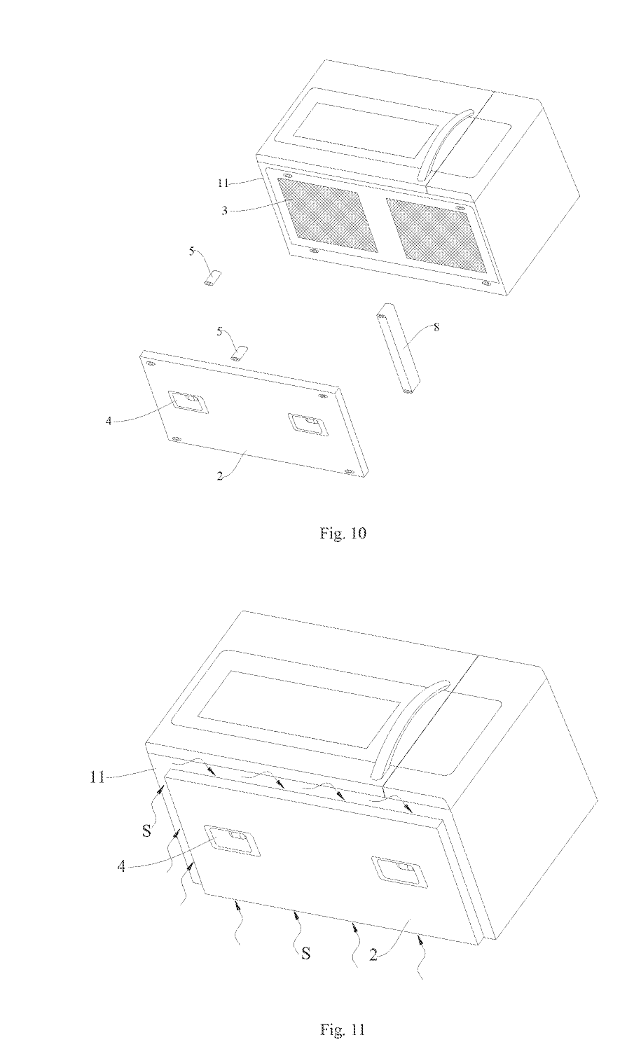

In the embodiment shown in FIG. 10, the baffle plate 2 is detachably mounted on the base plate 11 via the connecting column 5 and the sealing plate 8, and the sealing plate 8 seals the right opening 171 of the smoke collection cavity A. Advantageously, two connecting columns 5 are disposed adjacent to a left edge of the baffle plate 2 and spaced apart from each other in a front and rear direction, and the sealing plate 8 connects a right edge of the baffle plate 2 with the base plate 11 and seals the right opening 171 of the smoke collection cavity A. Thus, the cooking oil smoke S enters into the smoke collection cavity A via the front opening 174, the left opening 173 and the rear opening 172, as shown in FIG. 11.

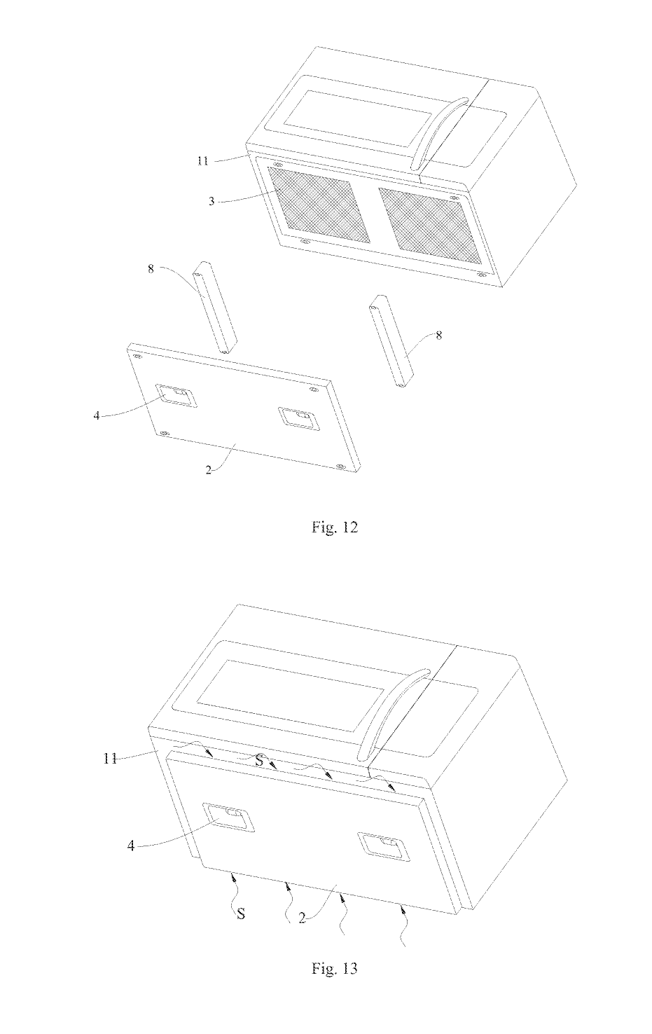

In the embodiment shown in FIG. 12, the baffle plate 2 is connected with the base plate 11 via two sealing plates 8, and the two sealing plates 8 seal the left opening 173 and the right opening 171 of the smoke collection cavity A. In other words, one sealing plate 8 connects a left edge of the baffle plate 2 with the base plate 11 and seals the left opening 173 of the smoke collection cavity A, while the other sealing plate 8 connects the right edge of the baffle plate 2 with the base plate 11 and seals the right opening 171 of the smoke collection cavity A. Thus, the cooking oil smoke S enters into the smoke collection cavity A via the front opening 174 and the rear opening 172, as shown in FIG. 13.

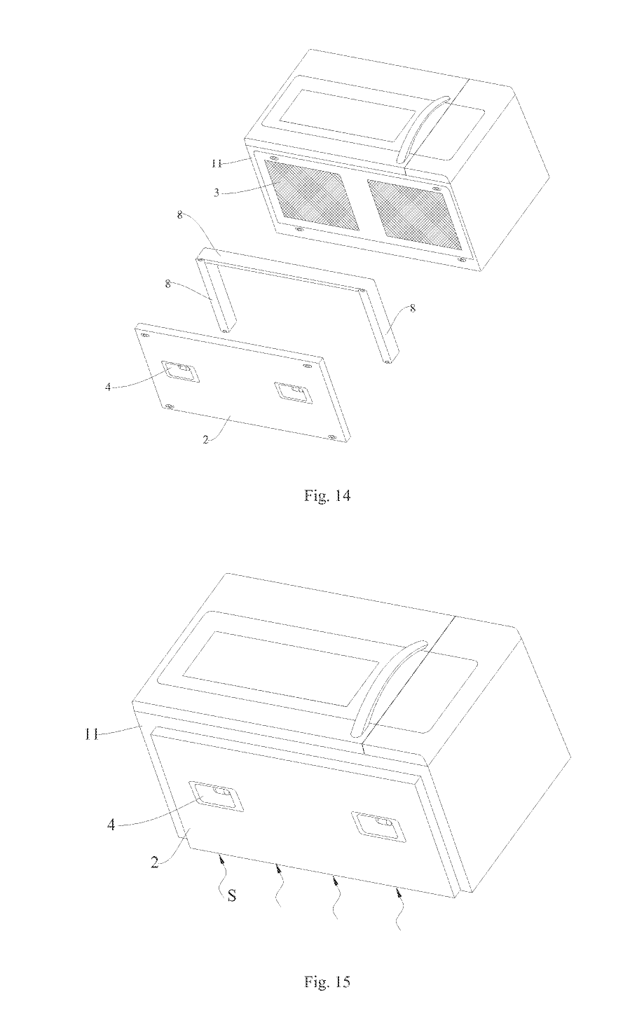

In the embodiment shown in FIG. 14, the baffle plate 2 is connected with the base plate 11 via three sealing plates 8, and the three sealing plates 8 seal the front opening 174, the left opening 173 and the right opening 171 of the smoke collection cavity A. In other words, the first sealing plate 8 connects the front edge of the baffle plate 2 with the base plate 11, and seals the front opening 174 of the smoke collection cavity A; the second sealing plate 8 connects the left edge of the baffle plate 2 with the base plate 11, and seals the left opening 173 of the smoke collection cavity A; and the third sealing plate 8 connects the right edge of the baffle plate 2 with the base plate 11, and seals the right opening 171 of the smoke collection cavity A. Thus, the cooking oil smoke S enters into the smoke collection cavity A via the rear opening 172 thereof, as shown in FIG. 15.

By changing the position of the sealing plates 8, the path through which the cooking oil smoke S enters into the smoke collection cavity A can be adjusted easily, thus facilitating adjusting the suctioning effect and improving the applicability of the over-the-range microwave oven 100.

A ventilation passage system of the over-the-range microwave oven according to embodiments of the present invention will be described below.

As mentioned above, the over-the-range microwave oven has the outer casing 1 defining the cooking cavity 13 therein and the baffle plate 2 disposed below and spaced apart from the base plate 11 of the outer casing 1.

The ventilation passage system of the over-the-range microwave oven 100 comprises the smoke collection cavity A formed between the base plate 11 and the baffle plate 2 and an exhaust passage 12 formed between the cooking cavity 13 and the outer casing 1. The exhaust passage 12 has the inlet 121 formed in the base plate 11 and the outlet 122. The exhaust passage 12 is communicated with the smoke collection cavity A via the inlet 121. Advantageously, the filter screen 3 is disposed at the inlet 121.

In one embodiment of the present invention, the exhaust passage 12 comprises the first exhaust passage B, the second exhaust passage C and the third exhaust passage D.

The first exhaust passage B is formed between the cooking cavity 13 and the base plate 11 and communicated with smoke collection cavity A via the inlet filter screen 3. The second exhaust passage C is formed between the cooking cavity 13 and at least one of the rear plate 14 and the side plate 15 of the outer casing 1. The third exhaust passage D is formed between the cooking cavity 13 and the top plate 16 of the outer casing 1 and communicated with the first exhaust passage B via the second exhaust passage C.

As shown in FIG. 3, the first exhaust passage B and the third exhaust passage D extend substantially in the horizontal direction, and the second exhaust passage C extends substantially in the up and down direction.

With the ventilation passage system of the over-the-range microwave oven according to embodiments of the present invention, by defining the smoke collection cavity A between the base plate 11 and the baffle plate 2, the cooking oil smoke S enters into the smoke collection cavity A through the opening of the smoke collection cavity A, thus improving the exhaust effect.

Advantageously, the base plate 11 and the baffle plate 2 are rectangular, for example, one, two or three of the front opening 174, the rear opening 172, the left opening 173 and the right opening 171 of the smoke collection cavity A may be sealed by the sealing plate 8, such that the path through which the cooking oil smoke S enters into the smoke collection cavity A can be adjusted.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom”, “peripheral” as well as derivative thereof (e.g., “horizontally”, “downwardly”, “upwardly”, etc.) should be construed to refer to the orientation as then described or as shown in the drawings under discussion. These relative terms are for convenience of description and do not require that the present invention be constructed or operated in a particular orientation.

In addition, terms such as “first” and “second” are used herein for purposes of description and are not intended to indicate or imply relative importance or significance. Thus, the feature defined with “first” and “second” may comprise one or more this feature. In the description, “a plurality of” means two or more than two, unless specified otherwise.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In the description of the present invention, a structure in which a first feature is “on” a second feature may include an embodiment in which the first feature directly contacts the second feature, and may also include an embodiment in which an additional feature is formed between the first feature and the second feature so that the first feature does not directly contact the second feature, unless specified otherwise. Furthermore, a first feature “on,” “above,” or “on top of” a second feature may include an embodiment in which the first feature is right “on,” “above,” or “on top of” the second feature, and may also include an embodiment in which the first feature is not right “on,” “above,” or “on top of” the second feature, or just means that the first feature is at a height higher than that of the second feature. While a first feature “beneath,” “below,” or “on bottom of” a second feature may include an embodiment in which the first feature is right “beneath,” “below,” or “on bottom of” the second feature, and may also include an embodiment in which the first feature is not right “beneath,” “below,” or “on bottom of” the second feature, or just means that the first feature is at a height lower than that of the second feature.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments can not be construed to limit the present invention, and changes, alternatives, and modifications can be made in the embodiments without departing from spirit, principles and scope of the present invention.

1. An over-the-range microwave oven, comprising:
an outer casing defining a cooking cavity and an exhaust passage therein, the exhaust passage defining an inlet formed in a base plate of the outer casing and an outlet; and
a baffle plate disposed below the base plate and facing the base plate so as to fully cover the inlet, wherein the baffle plate and the base plate are spaced apart from each other to form a smoke collection cavity between the baffle plate and the base plate.

2. The over-the-range microwave oven according to claim 1, further comprising a light disposed on the baffle plate.

3. The over-the-range microwave oven according to claim 1, wherein a plurality of cell orifices are formed in the baffle plate and extended through the baffle plate in a thickness direction of the baffle plate.

4. The over-the-range microwave oven according to claim 3, wherein a diameter of each of the plurality of cell orifices is about 1 mm to about 6 mm.

5. The over-the-range microwave oven according to claim 1, further comprising a filter screen disposed in the exhaust passage.

6. The over-the-range microwave oven according to claim 5, wherein the filter screen comprises an inlet filter screen disposed on the base plate and covering the inlet.

7. The over-the-range microwave oven according to claim 6, wherein the filter screen further comprises an outlet filter screen disposed at the outlet of the exhaust passage.

8. The over-the-range microwave oven according to claim 1, wherein the baffle plate and the base plate are spaced by a distance of about 10 mm to about 30 mm.

9. The over-the-range microwave oven according to claim 1, wherein an area of the baffle plate is equal to or smaller than that of the base plate.

10. The over-the-range microwave oven according to claim 1, wherein the exhaust passage comprises:
a first exhaust passage formed between the cooking cavity and the base plate and communicated with the smoke collection cavity via the inlet;
a second exhaust passage formed between the cooking cavity and at least one of a rear plate and a side plate of the outer casing; and
a third exhaust passage formed between the cooking cavity and a top plate of the outer casing and communicated with the first exhaust passage via the second exhaust passage.

11. The over-the-range microwave oven according to claim 1, wherein the baffle plate is detachably mounted on the base plate via a connecting member.

12. The over-the-range microwave oven according to claim 11, wherein the connecting member is configured as a connecting column defining a first end connected with the baffle plate and a second end connected with the base plate.

13. The over-the-range microwave oven according to claim 1, further comprising a sealing plate disposed between the baffle plate and the base plate for closing a portion of an opening of the smoke collection cavity.

14. The over-the-range microwave oven according to claim 13, wherein the baffle plate is mounted on the base plate via the sealing plate.

15. The over-the-range microwave oven according to claim 14, wherein the baffle plate is detachably mounted on the base plate via the sealing plate.

16. The over-the-range microwave oven according to claim 13, wherein the base plate and the battle plate are rectangular, and the sealing plate seals at most three of a front opening, a rear opening, a left opening and a right opening of the smoke collection cavity.

17. The over-the-range microwave oven according to claim 1, wherein a separation member is disposed between the base plate and the baffle plate, and the base plate and the baffle plate are connected detachably via a screw passing through the separation member.

18. The over-the-range microwave oven according to claim 17, wherein the separation member comprises:
a conical sleeve defining a small end and a large end;
a bottom plate sealing the small end of the conical sleeve; and
a flange formed at the large end of the conical sleeve.

19. A ventilation passage system of an over-the-range microwave oven, the over-the-range microwave oven having an outer casing defining a cooking cavity therein and a baffle plate disposed below and spaced apart from a base plate of the outer casing, and the ventilation passage system comprising:
a smoke collection cavity formed between the base plate and the baffle plate; and
an exhaust passage formed between the cooking cavity and the outer casing, defining an inlet formed in the base plate and an outlet, and communicated with the smoke collection cavity via the inlet, wherein the inlet is fully covered by the baffle plate.

20. The ventilation passage system according to claim 19, wherein the exhaust passage comprises:
a first exhaust passage formed between the cooking cavity and the base plate and communicated with the smoke collection cavity via the inlet;
a second exhaust passage formed between the cooking cavity and at least one of a rear plate and a side plate of the outer casing; and
a third exhaust passage formed between the cooking cavity and a top plate of the outer casing and communicated with the first exhaust passage via the second exhaust passage.

21. The ventilation passage system according to claim 19, wherein at least a portion of an opening of the smoke collection cavity is sealed.

22. The ventilation passage system according to claim 21, wherein the base plate and the baffle plate are rectangular, and at most three of a front opening, a rear opening, a left opening and a right opening of the smoke collection cavity are sealed.

23. An over-the-range microwave oven, comprising:
an outer casing defining a cooking cavity and an exhaust passage therein, the exhaust passage defining an inlet formed in a base plate of the outer casing and an outlet; and
a baffle plate disposed below the base plate and facing the base plate so as to fully cover the inlet, wherein the baffle plate and the base plate are spaced apart from each other to form a smoke collection cavity between the baffle plate and the base plate;
wherein the baffle plate is impermeable to air such that air to be filtered through the inlet enters the smoke collection cavity between an outer edge of the baffle plate and the base plate.

24. The over-the-range microwave oven according to claim 23, wherein the baffle plate does not include one or more openings configured to allow air to pass through the baffle plate in a thickness direction of the baffle plate.
